(19) United States
(12) Patent Application Publication
(10) Pub. No.: US 2015/0366752 A1
(43) Pub. Date: Dec. 24, 2015

(54) Waterfall Hot Tub

(71) Applicant: LPI, Inc., Kingsport, TN (US)

(72) Inventor: David E. Hatley, Gray, TN (US)

(21) Appl. No.: 14/736,356

(22) Filed: Jun. 11, 2015

Related U.S. Application Data
(60) Provisional application No. 62/016,416, filed on Jun. 24, 2014.

(51) Int. Cl. A61H 33/00

(52) U.S. Cl. CPC A61H 33/0087; A61H 33/601

(57) ABSTRACT

A hot tub is disclosed having a plurality of walls defining an upper perimeter and a central well for holding a measure of heated water. A recirculation system is provided comprising a pump in fluid communication with the well. The pump is configured to direct water from the well for treatment by at least one treatment device selected from the group consisting of a filter, a heater, and a chemical diffuser. A waterfall fountain extends along each of the plurality of walls along the upper perimeter. The waterfall fountain is in fluid communication with the pump downstream of the treatment device and is configured to receive at least a portion of water treated by the treatment device and to direct the treated water back into the well.

### CROSS-REFERENCE TO RELATED APPLICATIONS

This application claims the benefit of U.S. Provisional Patent Application Ser. No. 62/016,416, filed on Jun. 24, 2014, which is incorporated herein in its entirety by reference.

### STATEMENT REGARDING FEDERALLY-SPONSORED RESEARCH OR DEVELOPMENT

Not Applicable

### BACKGROUND OF THE INVENTION

1. Field of Invention

The present general inventive concept relates to hot tubs and whirlpools, and more particularly, to a waterfall system for hot tubs and whirlpools and a hot tub and whirlpool incorporating such a system.

2. Description of the Related Art

Hot tubs, whirlpools, spas, and similar devices (hereinafter “hot tubs”) of the type generally comprising a large tub or small pool full of heated water, are commonly used for hydrotherapy, recreation, exercise, and/or physical therapy. Many modern hot tubs include a recirculation system for passing water within the hot tub through a heater, filtration system, and/or chemical dispenser before returning the recirculated water to the interior of the hot tub. Numerous devices exist for returning recirculated water to a hot tub, and many of these return devices also provide additional utility. For example, many hot tubs incorporate jets for returning recirculated water to the interior of the hot tub. Such jets may also be used to generate water flow or air flow within the hot tub and/or to direct heat and/or pressure to a user within the hot tub. Thus, such jets may be used for treatment of sore muscles, for relaxation, such as for example after exercise or rigorous physical activity, or for other recreational purposes.

In several designs for hot tubs, one or more features may be included to provide ambiance or aesthetic qualities to the hot tub. For example, many modern hot tubs include lighting either above or below the water surface, speakers for electronic music players, and/or television systems. One feature which is often included in modern hot tub designs is a small waterfall fountain. A waterfall fountain may serve any of numerous functions within a hot tub. For example, a waterfall fountain may be used to direct recirculated water into the hot tub interior and/or against a user positioned near the waterfall. A waterfall fountain may also be used to provide an asthetically pleasing appearance or sound to the hot tub or to mask certain features of the hot tub from view, such as for example a filtration or recirculation intake port within the hot tub.

In traditional waterfall fountains incorporated into modern hot tub designs, a significant limitation arises in that the waterfall fountain is typically accessible and/or visible at only a single location, or a limited number of locations, within the hot tub. Thus, it is possible for a user to be positioned in a hot tub such that the user may not access and/or view the waterfall. For example, if a user is seated in the hot tub away from the waterfall, and if the user is also not facing the waterfall, it is possible that the user may neither see nor access the waterfall, and thus may not benefit from the aesthetic and/or therapeutic qualities of the waterfall. Thus, a waterfall fountain for a hot tub which is accessible from all, or nearly all, locations within the hot tub, and a hot tub incorporating such a waterfall fountain, are desired.

### BRIEF SUMMARY OF THE INVENTION

The present general inventive concept, in various example embodiments, includes a waterfall system for a hot tub and a hot tub incorporating such a system. Various example embodiments of the present general inventive concept may include a hot tub having a plurality of walls defining an upper perimeter and a central well for holding a measure of water. A recirculation system may be provided comprising a pump in fluid communication with the well. The pump may be configured to direct water from the well for treatment by at least one treatment device and return treated water to the well. In various embodiments, a waterfall fountain may extend along each of the plurality of walls along the upper perimeter. The waterfall fountain may be in fluid communication with the pump downstream of the at least one treatment device and may be configured to receive at least a portion of the treated water and to direct the treated water back into the well.

In various embodiments, the waterfall fountain may comprise a channel extending along the upper perimeter and configured to receive the portion of treated water. The channel may have an interior upper edge between the channel and the well and an exterior upper edge opposite the channel from the well. The exterior upper edge may extend upward of the interior upper edge. Thus, excess water may be received within the channel and may flow over the interior upper edge into the well. In various embodiments, the interior upper edge may be configured to allow laminar flow of water from the channel into the well. In other embodiments, the interior upper edge may be configured to allow projected flow of water from the channel inward from the hot tub walls. In various embodiments, the waterfall fountain may further comprise at least one control for adjusting the rate of flow of treated water into the channel.

In various embodiments, the waterfall fountain may further comprise a cascade zone defined by at least one of the plurality of side walls. The cascade zone may extend along the channel inward and below the interior upper edge. Thus, water flowing over the interior upper edge may flow along at least a portion of the cascade zone into the well. In various embodiments, the cascade zone may comprise a plurality of inwardly and downwardly tapered steps, each step extending substantially along the perimeter parallel to the interior upper edge. At least one of the plurality of steps may define a height different from a height of another of the steps. In various embodiments, at least one of the plurality of steps may define a width different from a width of another of the steps. In some embodiments, the cascade zone may define an overall tapered shape downward inward from the interior upper edge to a lower edge of the cascade zone. Thus, water flowing over the interior upper edge may maintain contact along the height of the cascade zone as it flows into the well.

Various example embodiments of the present general inventive concept may include a waterfall hot tub comprising a plurality of walls cooperating to define a central well holding a measure of water in an interior thereof, the central well defining an upper perimeter. The waterfall hot tub may further comprise a recirculation system comprising a pump in fluid communication with the interior of the well below a standing water surface of the water, the pump configured to direct water from the well interior for treatment by at least one treatment device. The waterfall hot tub may further comprise a slot extending along each of the plurality of walls above the standing water surface of the water, the slot being in fluid communication with the pump and configured to receive treated water from the at least one treatment device and to discharge the received treated water into the well interior. In various embodiments, the waterfall hot tub may further comprise a channel extending along the upper perimeter, the channel having an interior upper edge between the channel and the well, and a cover overlying the channel and defining an inner edge extending substantially along the interior upper edge. In such embodiments, the interior upper edge of the channel and the inner edge of the cover may cooperate to define the slot.

In various embodiments, the channel may be in fluid communication with the pump and may be configured to receive treated water from the at least one treatment device. Thus, excess treated water received within the channel may flow over the interior upper edge and through the slot. In some embodiments, the cover may be releasably secured to the upper perimeter. In various embodiments, the waterfall hot tub may further comprise at least one control for adjusting the rate of flow of treated water into the channel. The control may be configured to allow adjustment of the rate of flow of treated water into the channel to a sufficiently high magnitude that treated water discharged through the slot projects inwardly from the slot and away from the walls. The control may be further configured to allow adjustment of the rate of flow of treated water into the channel to a sufficiently low magnitude that treated water discharged through the slot flows downward along the walls. In various embodiments, each of the walls may cooperate to define a cascade zone extending inward of, and beneath, the slot. The cascade zone may comprise a plurality of inwardly and downwardly tapered steps, each step extending substantially parallel to the slot.

Additional aspects and advantages of the present general inventive concept will be set forth in part in the description which follows, and, in part, will be obvious from the description, or may be learned by practice of the present general inventive concept.

### BRIEF DESCRIPTION OF THE SEVERAL VIEWS OF THE DRAWINGS

The following example embodiments are representative of example techniques and structures designed to carry out the objects of the present general inventive concept, but the present general inventive concept is not limited to these example embodiments. In the accompanying drawings and illustrations, the sizes and relative sizes, shapes, and qualities of lines, entities, and regions may be exaggerated for clarity. A wide variety of additional embodiments will be more readily understood and appreciated through the following detailed description of the example embodiments, with reference to the accompanying drawings in which:

FIG. 1 is a perspective view showing one embodiment of a waterfall hot tub constructed in accordance with several features of the present general inventive concept;

FIG. 2 is a cross-sectional view of the waterfall hot tub of FIG. 1, showing a schematic representation of the recirculation system;

FIG. 3 is a cross-sectional view showing the waterfall portion of the hot tub of FIG. 1; and

FIG. 4 is cross-sectional view showing a waterfall portion of another embodiment of a waterfall hot tub constructed in accordance with several features of the present general inventive concept;

FIG. 5 is a cross-sectional view of the waterfall hot tub of FIG. 4, showing a schematic representation of the recirculation system; and

FIG. 6 is a perspective view of the waterfall hot tub of FIG. 5.

### DETAILED DESCRIPTION OF THE INVENTION

Reference will now be made to the example embodiments of the present general inventive concept, examples of which are illustrated in the accompanying drawings and illustrations. The following detailed description is provided to assist the reader in gaining a comprehensive understanding of the structures and fabrication techniques described herein. The example embodiments are described herein in order to explain the present general inventive concept by referring to the figures. However, various changes, modification, and equivalents of the structures and fabrication techniques described herein will be suggested to those of ordinary skill in the art. The progression of fabrication operations described are merely examples, and the sequence type of operations is not limited to that set forth herein and may be changed as is known in the art, with the exception of operations necessarily occurring in a certain order. Also, description of well-known functions and constructions may be omitted for increased clarity and conciseness.

Note that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. Spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

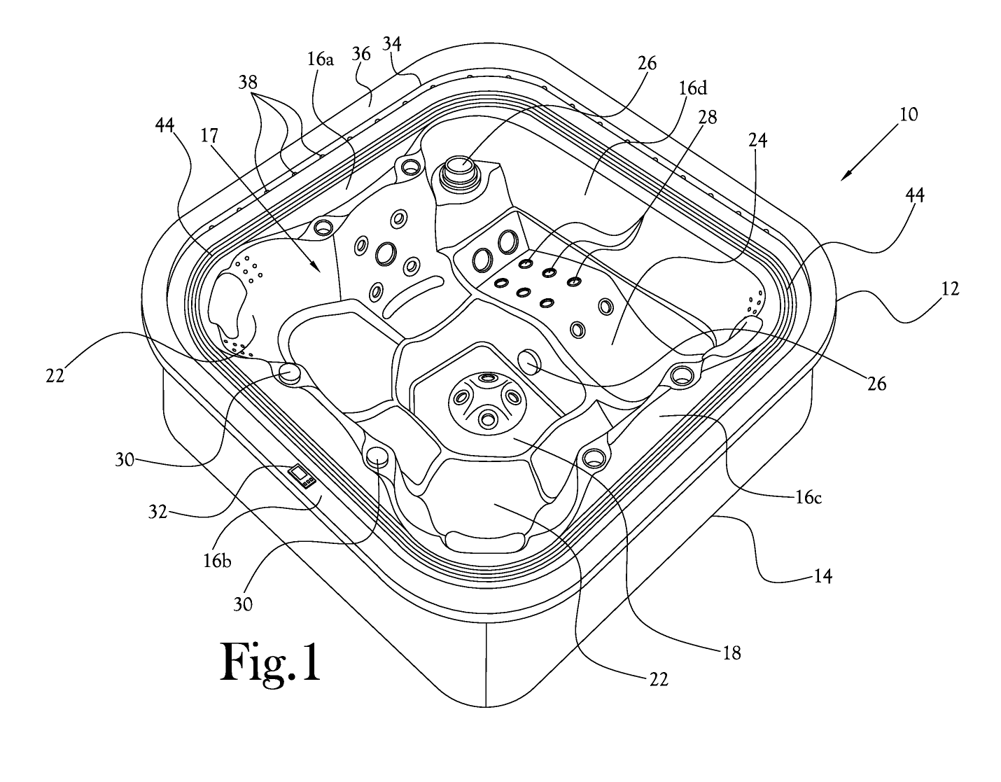

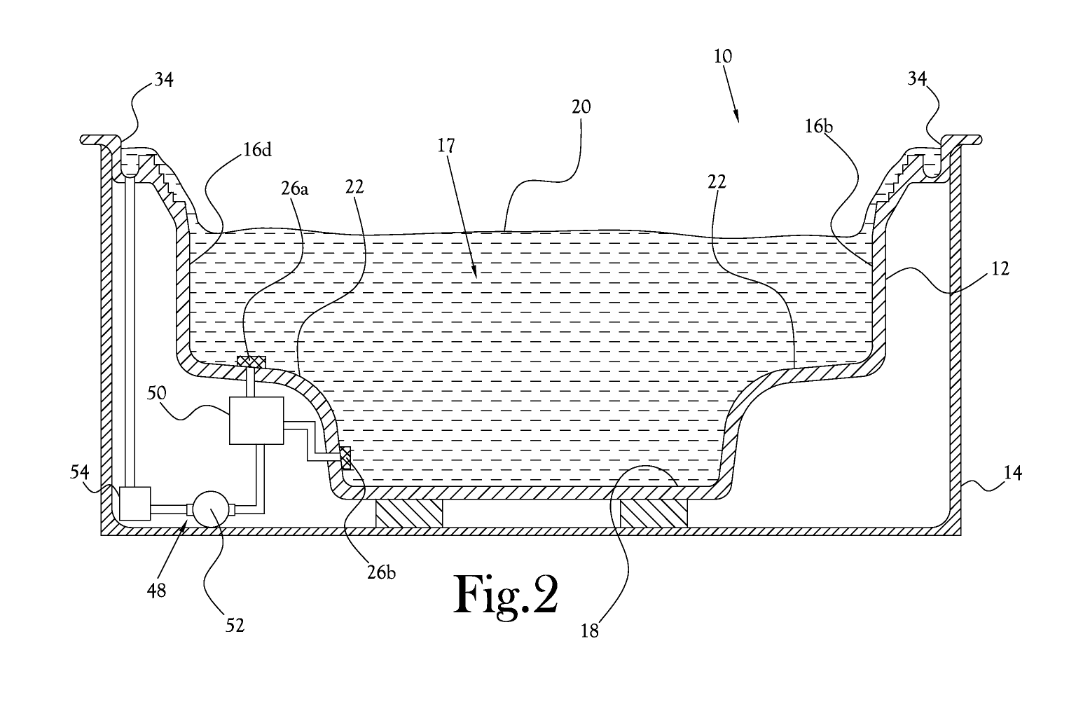

According to several features of the present general inventive concept, a waterfall hot tub and hot tub incorporating a waterfall are described herein and in the accompanying figures. The hot tub, illustrated generally at 10 in the figures, includes a generally tub-shaped shell 12 which is supported by a frame structure 14. With reference to FIGS. 1 and 2, in one embodiment, the shell 12 defines generally a plurality of side walls 16a-16d and a floor surface 18 which cooperate to define an interior well 17 configured to hold a volume of water 20. In various embodiments, as in the illustrated embodiment, the shell 12 defines a plurality of depressions, cavities, and other such shapes along the side walls 16 and floor 18 which may be used to comfortably position a user within the well 17 at least partially submerged in the water 20. For example, in the illustrated embodiment, a plurality of inwardly-facing seat-shaped depressions 22 are provided along first, second, and third side walls 16a-16c. The seat-shaped depressions 22 are shaped to generally conform to a posterior portion of a user in an upright seated position, such that a user may sit upright comfortably in the depressions 22. In the illustrated embodiment, a lounger-shaped depression 24 is defined along a fourth side wall 16d. The lounger-shaped depression 24 is shaped to generally conform to a posterior portion of a user in a reclined seated position, such that a user may sit in a reclined position comfortably in the depression 24. Each of these depressions 22, 24 may be used, for example, as a seat, standing surface, kneeling surface, etc., by a user in the hot tub 10. However, it will be recognized that numerous other configurations for the depressions 22, 24 exist which may be used without departing from the spirit and scope of the present general inventive concept. Moreover, it will be further recognized that inclusion of the depressions 22, 24 is not necessary to accomplish the present general inventive concept. To this end, in certain embodiments (not shown), the side walls 16a-16d and floor 18 may define relatively planar surfaces joined along respective corresponding edges to define an interior volume having a relatively uniform shape, such as a rectangular prismatic shape, cylindrical shape, or the like.

In various embodiments, the waterfall hot tub 10 includes a recirculation system 48 which is configured to draw water 20 from within the well 17, subject the drawn water to treatment by at least one treatment device, and thereafter to reintroduce the water into the well 17. For example, in various embodiments, the recirculation system 48 may be configured to pass the drawn water through a screen or filter in order to remove particulates or other contaminants from the water. The recirculation system 48 may also, or alternatively, be configured to heat the drawn water via a heater, to introduce chemicals to the water via a chemical diffuser, to soften or harden the water via a suitable water softening or hardening device, etc. Thereafter, the recirculation system 48 is configured to return the water to the well 17.

FIG. 2 illustrates a cross-sectional view of the hot tub 10 of FIG. 1 and includes a schematic representation of one embodiment of a recirculation system 48. With reference to FIGS. 1 and 2, in various embodiments, at least one intake opening 26 is provided at a location at or below the surface of the water 20 within the well 17 and is configured to allow water 20 from the well 17 to enter into the recirculation system. In the illustrated embodiment, a first intake opening 26a is positioned at a foot end of the lounger depression 24, near an intersection between the first and fourth walls 16a, 16d, respectively, and a second intake opening 26b is provided along the second wall 16b, near the intersection between the second wall 16b and the floor surface 18. It will be understood that the specific location of the intake openings 26 within the shell 12 is not critical and may vary without departing from the spirit and scope of the present general inventive concept. In the illustrated embodiment, each of the intake openings 26a, 26b incorporates a screen and is in fluid communication with a filter 50 and a pump 52 via hoses, tubes, or other conduit of the type known to one of ordinary skill in the art. The pump 52 is configured to draw water 20 from within the well 17 through the respective screens of the intake openings 26a, 26b and to move the drawn water through the associated filter 50, thereby subjecting the drawn water to screening and filtration of particulates and other such contaminants from the water. In the illustrated embodiment, the pump 52 is further configured to move the screened and filtered water through a heater 54. The heater 54 is configured to heat the water to a desired temperature, whereupon the pump 52 is further configured to move the treated water back into the well 17. As discussed above, additional treatment devices, such as for example chemical diffusers or the like, may be incorporated into the recirculation system 48 without departing from the spirit and scope of the present general inventive concept.

In the illustrated embodiment, a plurality of jets 28 are provided at various locations throughout the shell 12. Each of the jets 28 is placed in downstream fluid communication with at least one filter 50, pump 52, and heater 54. Thus, at least a portion of the water which has passed through the filter and heater may be directed through one or more of the jets 28 and into the well 17. In several embodiments, suitable valves 30 are optionally provided to selectively allow and disallow water flow to certain or all of the jets 28 around the shell 12, thus enabling a user to switch water flow on and off through specific groups of jets 28. In several embodiments, suitable controls and apparatus of the type known to one of skill in the art are further provided to allow the water flowing through the jets 28 to be mixed with air, and to adjust the amount of air mixed with the water flowing through the jets. In several embodiments, a control panel 32 is provided at a location along an upper portion of the shell 12 and is equipped with suitable controls of the type known to one of ordinary skill in the art configured to control operation of the pumps 52, heater, and/or other treatment devices provided in the waterfall hot tub 10. In the illustrated embodiment, the control panel 32 is provided at a central location along an upper edge of the second wall 16b. However, those of skill in the art will recognize that numerous suitable locations exist for placement of the control panel 32, and the control panel 32 may be disposed at such locations without departing from the spirit and scope of the present general inventive concept.

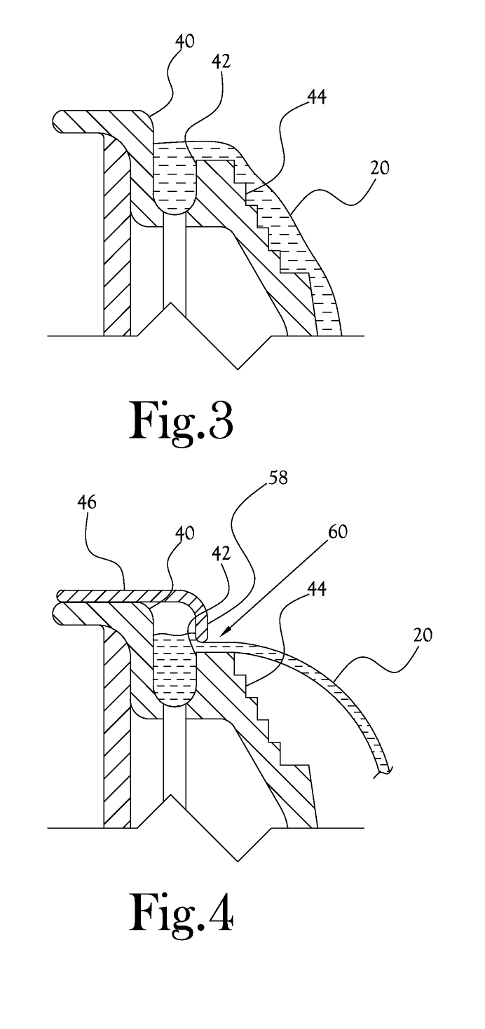

In accordance with several features of the present general inventive concept, a channel 34 is provided along an upper perimeter 36 the shell 12, along each of the four walls 16. A plurality of outlet openings 38 are provided at various locations along the channel 34 in fluid communication with the recirculation system 48 downstream of the above-discussed treatment devices, such that at least a portion of the water drawn from within the well 17 and passed through the treatment devices may be directed through the outlet openings 38 and into the channel 34. As better illustrated in FIG. 3, in the present embodiment, the channel 34 defines generally an exterior upper edge 40 and an opposite interior upper edge 42 extending about the upper perimeter 36 of the shell 12. The exterior upper edge 40 of the channel 34 extends slightly higher in elevation than the interior upper edge 42, such that, as the channel 34 fills with water entering through the outlet openings 38 to the interior upper edge 42, excess water within the channel 34 is allowed to spill over the interior upper edge 42 and into the well 17. Thus, the channel 34 serves as a waterfall fountain extending along the upper perimeter 36 of the shell 12 which is configured to receive filtered and heated water from the recirculation system 48 and allow such water to spill down each of the walls 16a-16d of the shell 12, thereby allowing the water to return to the interior well 17 of the shell 12.

In several embodiments, one of the above-discussed control valves 30 may be provided for adjusting the rate of flow of water into the channel 34 through the various outlet openings 38. In some embodiments, this control valve is infinitely adjustable between an opened position, in which water is allowed into the channel 34 through the various outlet openings 38 at a maximum output rate of flow of the pumps 52 of the recirculation system, and a closed position, in which little or no water is allowed through the outlet openings 38. In several embodiments, the rate of flow of water into the channel 34 may be adjusted to a sufficient magnitude such that water flowing over the interior upper edge 42 of the channel 34 projects inwardly from the walls 16 of the shell 12. In several embodiments, the rate of flow of water into the channel 34 through the various outlet openings 38 is further adjustable to one or more magnitudes in which water may flow down the sides of one or more of the side walls 16 absent the above-described outward projection from the side walls 16.

In various embodiments, including the illustrated embodiment, one or more side walls 16a-16d of the shell 12 defines a cascade zone 44 extending along the upper perimeter 36 of the shell 12, inward of the interior upper edge 42 of the channel 34. In several embodiments, the cascade zone 44 extends generally below the interior upper edge 42 of the channel 34 and above the intended standing water surface of the waterfall hot tub 10. The cascade zone 44 is generally positioned and shaped such that water which is allowed to spill over the interior upper edge 42 of the channel 34 may flow along the surface of the cascade zone 44 and into the well 17. In several embodiments, the cascade zone 44 is further shaped such that water flowing along the cascade zone 44 is subject to slight agitation, thereby inducing turbulence or otherwise disrupting laminar flow of the water. For example, in the embodiment of FIG. 3, the cascade zone 44 defines a plurality of inwardly and downwardly tapered steps, with each step extending substantially along the perimeter 36 of the shell 12. In the illustrated embodiment, certain of the steps define a height or width slightly different that the corresponding height or width of others of the steps. Thus, the cascade zone 44 defines a slightly irregular surface along its height dimension. In other embodiments, the cascade zone 44 may define additional shapes in order to allow variance in the surface of the cascade zone 44 along the height dimension thereof. For example, in other embodiments, the cascade zone 44 may define a plurality of inwardly tapered slopes or curves, channels, protrusions and recesses, or the like, and in still other embodiments, the cascade zone may define combinations of such shapes, such that varying textures and surfaces are provided along the height and/or width dimension of the cascade zone 44. Those of skill in the art will recognize other suitable shapes which may be used for the cascade zone 44 without departing from the spirit and scope of the present general inventive concept.

As mentioned above, in several embodiments, the above-discussed irregular surface of the cascade zone 44 serves to provide turbulence to water flowing from the interior upper edge 42 of the channel 34 downward and along the cascade zone 44 and into the well 17. It will be appreciated that such turbulent water flowing from the interior upper edge 42 of the channel 34 downward along the cascade zone 44 may provide numerous aesthetic and/or therapeutic qualities to the waterfall hot tub 10. For example, in the illustrated embodiment, a user positioned within the waterfall hot tub 10 may readily see and hear the above-discussed water flowing along the cascade zone 44 from a seated or reclined position at any of the above-discussed seat depressions 22, 24 along the interior of the shell 12. Furthermore, a user seated in any of the above-discussed seat depressions 22, 24 may position his or her head and neck proximate a portion of the cascade zone 44, such that water flowing along the cascade zone 44 may be allowed to flow along the user's head, neck, and/or shoulders, thereby allowing the user the therapeutic benefit of warm water flowing along these areas.

In several embodiments, the cascade zone 44 defines an overall tapered shape downward inward from the interior upper edge 42 of the channel 34 to a lower edge of the cascade zone 44. For example, in the embodiment of FIG. 3, each of the steps forming the cascade zone 44 extends inward of, and beneath, a previous step, such that the cascade zone 44 extends either downward from, or inward from, the interior upper edge 42 of the channel 34 along the entire height of the cascade zone. In such embodiments, when water is allowed to spill from the interior upper edge 42 of the channel 34 and flow downward along the cascade zone 44, such water flows in contact along the entire surface of the cascade zone 44 before reaching the standing water surface of the waterfall hot tub 10. It will be appreciated that several additional advantages may be provided by such embodiments in addition to the above-discussed aesthetic and/or therapeutic benefits. For example, in embodiments in which water flowing along the cascade zone 44 maintains contact along the entire surface of the cascade zone 44 before reaching the standing water surface of the waterfall hot tub 10, it will be appreciated that such water may serve to rinse the surfaces of the cascade zone 44 and any other surfaces between the interior upper edge 42 of the channel 34 and the standing water surface of the waterfall hot tub 10. Thus, in several embodiments the above-discussed channel 34 and cascade zone 44 may provide a self-cleaning feature for portions of the shell 12 situated below the interior upper edge 42 of the channel 34.

In the illustrated embodiment, the channel 34 extends continuously about the entire upper perimeter 36 of the shell 12. However, while it is understood that, in several embodiments, the channel 34 may extend generally about the upper perimeter 36 of the shell 12, it will be recognized by one of ordinary skill in the art that the channel 34 need not extend about the entire upper perimeter 36 of the shell 12 in order to accomplish the various features of the present general inventive concept. For example, in some embodiments, the channel 34 may define a small interrupt along the upper perimeter 36 of the shell 12, which may in certain embodiments be used as a location for positioning one or more other features of the hot tub 10. For example, in one embodiment, an interrupt is provided in the channel 34, and the control panel 32 is positioned thereon. In other words, in one embodiment, the channel 34 defines a first end positioned adjacent a first side of the control panel 32, and the channel 34 extends around the upper perimeter 36 of the shell 12 and terminates at a second end positioned near the opposite second side of the control panel 32. In other embodiments, the channel 34 may extend continuously about the entire upper perimeter 36 of the shell 12, but may wrap along an interior side of the control panel 32. Those skilled in the art will recognize other configurations of the channel 34 which may be used without departing from the spirit and scope of the present general inventive concept.

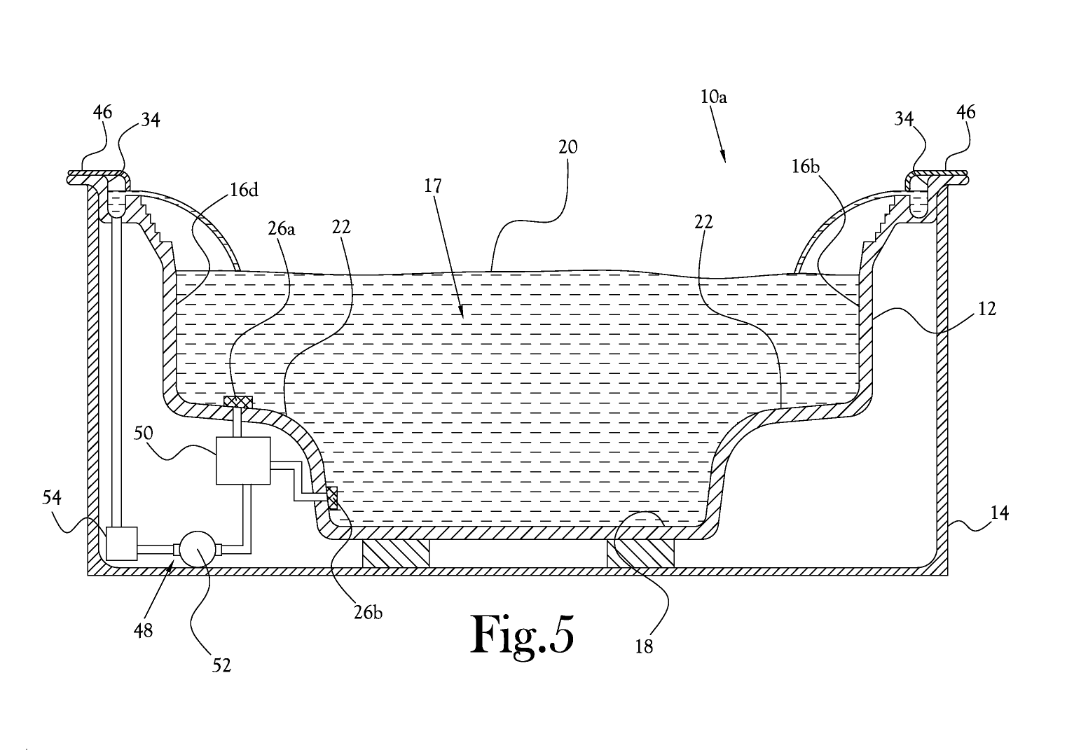

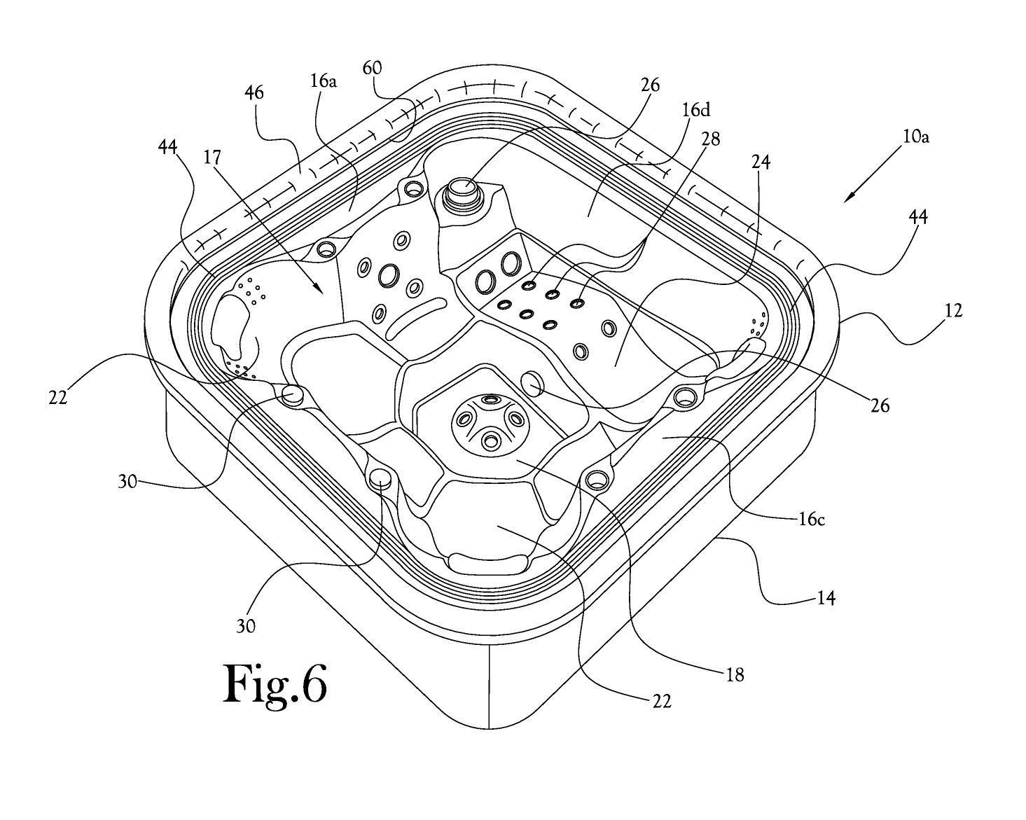

FIGS. 4 and 5 illustrate another embodiment of a waterfall hot tub 10a constructed in accordance with several features of the present general inventive concept. In the embodiment of FIGS. 4 and 5, a cover 46 is provided overlying the channel 34. In various embodiments, the cover 46 may serve to limit access to the interior of the channel 34. Thus, the cover 46 may, for example, reduce the risk of injury due to slipping or other perils while entering or leaving the hot tub 10, and may further reduce the likelihood of debris or foreign matter entering the interior of the channel 34. In the illustrated embodiment, the cover 46 includes a relatively flat upper portion 56 extending from the upper perimeter 36 the shell 12 and overlying the channel 34, and a substantially straight and horizontal interior edge 58 extending toward the interior upper edge 42 of the channel 34. In certain embodiments, the cover 46 may be releasably secured along the upper perimeter 36 the shell 12 via suitable releasable fasteners, frictional connection, or the like. In other embodiments, the cover 46 may be permanently affixed along the upper perimeter 36 the shell 12 as by suitable fasteners, welds, adhesive, integral connection, or the like.

With reference to FIGS. 4 and 5, the interior edge 58 of the cover 46 is separated slightly from the interior upper edge 42 of the channel. Thus, the interior edge 58 of the cover 46 cooperates with the interior upper edge 42 of the channel 34 to form a slot 60 extending along the upper perimeter 36 of the shell 12. In this configuration, water flowing out of the channel 34 is directed through the slot 60 as it flows over the interior upper edge 42 of the channel 34 and into the well 17. It will be recognized that the distance of separation between the interior edge 58 of the cover 46 and the interior upper edge 42 of the channel 34 defines generally the height of the slot 60, and thus defines the overall size of the opening provided by the slot 60 to allow water to flow from the channel 34 into the well 17. In various embodiments, the rate of flow of water into the channel 34 is adjustable such that the characteristics of water flowing from the channel 34 through the slot 60 can be adjusted. For example, as shown in FIG. 4, in certain embodiments, the rate of flow of water into the channel 34 may be adjusted to a sufficiently high magnitude in relation to the height of the slot 60 that water flowing out of the channel 34 through the slot 60 projects inwardly from the slot 60 and away from the respective side walls 16a-16d of the shell 12. In other embodiments, the rate of flow of water into the channel 34 may be adjusted to a sufficiently low magnitude in relation to the height of the slot 60 that water flowing out of the channel 34 through the slot 60 may flow downward along the cascade zone 44 positioned below the interior upper edge 42 of the channel 34.

In various embodiments, in addition to the above-discussed adjustability of the rate of flow of water through the channel 34, the slot 60 may further be shaped in such a way as to control the characteristics of water flowing from the channel 34 through the slot 60. For example, in certain embodiments, the slot 60 is sized and shaped to form and direct substantially laminar flow of water from the slot 60 at a maximum rate of flow of water through the channel 34. In other embodiments, the slot 60 is sized and shaped to form and direct substantially turbulent flow of water from the slot 60 at a maximum rate of flow of water through the channel 34, while also allowing substantially laminar flow of water at rates of flow less than the maximum rate of flow of water through the channel 34. In still other embodiments, the slot 60 is sized and shaped to form and direct substantially turbulent flow of water from the slot 60 throughout the range of maximum and minimum rates of flow of water through the channel 34.

In the illustrated embodiment, both the interior upper edge 42 of the channel 34 and the interior edge 58 of the cover 46 are substantially straight and horizontal, and the interior edge 58 of the cover 46 extends substantially parallel to the interior upper edge 42 of the channel 34. Thus, the slot 60 defines a substantially uniform height and extends in a substantially horizontal path along the upper perimeter 36 of the shell 12. In this embodiment, water flowing from the channel 34 through the slot 60 also defines a relatively flat, uniform profile. It will be recognized that, in other embodiments, the slot 60 may define a substantially non-uniform height along the upper perimeter 36 of the shell 12, or may extend along a substantially non-straight and/or non-horizontal path along the upper perimeter 36 of the shell 12, such that water flowing from the channel 34 through the slot 60 also defines a relatively non-straight and/or non-horizontal profile. For example, in several embodiments (not shown), the interior edge 58 of the cover 46 and the upper edge 42 of the channel 34 each maintain a substantially side-by-side, parallel relationship to one another about the upper perimeter 36 of the shell 12. However, each extends along a curved, wavy, or other such irregular path about the upper perimeter 36 of the shell 12. In such embodiments, the slot 60 defines a similar irregular profile about the upper perimeter 36 of the shell 12, and thus, water flowing from the slot 60 also defines a similar irregular profile. In other embodiments, the interior edge 58 of the cover 46 and the upper edge 42 of the channel 34 divert from and extend toward one another about the upper perimeter 36 of the shell 12, such that the resulting slot 60 is thicker in certain portions and thinner, or interrupted, in others. In such embodiments, water flowing from the slot 60 defines a similar profile of thicker and thinner, or interrupted portions. Those of skill in the art will recognize other configurations which are suitable to accomplish the above-discussed slot, and such configurations may be used without departing from the spirit and scope of the present general inventive concept.

From the foregoing description, it will be recognized that a waterfall hot tub and hot tub incorporating a waterfall have been provided in various embodiments. It is noted that the simplified diagrams and drawings do not illustrate all the various connections and assemblies of the various components, however, those skilled in the art will understand how to implement such connections and assemblies, based on the illustrated components, figures, and descriptions provided herein, using sound engineering judgment. Furthermore, numerous variations, modifications, and additional embodiments are possible, and accordingly, all such variations, modifications, and embodiments are to be regarded as being within the spirit and scope of the present general inventive concept. For example, regardless of the content of any portion of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated.

While the present general inventive concept has been illustrated by description of several example embodiments, and while the illustrative embodiments have been described in detail, it is not the intention of the applicant to restrict or in any way limit the scope of the general inventive concept to such descriptions and illustrations. Instead, the descriptions, drawings, and claims herein are to be regarded as illustrative in nature, and not as restrictive, and additional embodiments will readily appear to those skilled in the art upon reading the above description and drawings. Additional modifications will readily appear to those skilled in the art. Accordingly, departures may be made from such details without departing from the spirit or scope of applicant's general inventive concept.

Having thus described the aforementioned invention, what is claimed is:

1. In a hot tub having a plurality of walls defining an upper perimeter and a central well for holding a measure of water, and having a recirculation system comprising a pump in fluid communication with the well, the pump configured to direct water from the well for treatment by at least one treatment device and return treated water to the well, the improvement comprising:
a waterfall fountain extending along each of the plurality of walls along the upper perimeter, the waterfall fountain in fluid communication with the pump downstream of the at least one treatment device and configured to receive at least a portion of the treated water and to direct the treated water back into the well.

2. The hot tub of claim 1, the waterfall fountain comprising a channel extending along the upper perimeter and configured to receive the portion of treated water.

3. The hot tub of claim 2, the channel having an interior upper edge between the channel and the well and an exterior upper edge opposite the channel from the well, the exterior upper edge extending upward of the interior upper edge, whereby excess water received within the channel may flow over the interior upper edge into the well.

4. The hot tub of claim 3, the interior upper edge being configured to allow laminar flow of water from the channel into the well.

5. The hot tub of claim 3, the interior upper edge being configured to allow projected flow of water from the channel inward from the hot tub walls.

6. The hot tub of claim 3, the waterfall fountain further comprising at least one control for adjusting the rate of flow of treated water into the channel.

7. The hot tub of claim 6, the waterfall fountain further comprising a cascade zone defined by at least one of the plurality of side walls and extending along the channel inward and below the interior upper edge, whereby water flowing over the interior upper edge may flow along at least a portion of the cascade zone into the well.

8. The hot tub of claim 7, the cascade zone comprising a plurality of inwardly and downwardly tapered steps, each step extending substantially along the perimeter parallel to the interior upper edge.

9. The hot tub of claim 8, at least one of the plurality of steps defining a height different from a height of another of the steps.

10. The hot tub of claim 9, at least one of the plurality of steps defining a width different from a width of another of the steps.

11. The hot tub of claim 8, the cascade zone defining an overall tapered shape downward inward from the interior upper edge to a lower edge of the cascade zone, whereby water flowing over the interior upper edge maintains contact along the height of the cascade zone as it flows into the well.

12. A waterfall hot tub comprising:
a plurality of walls cooperating to define a central well holding a measure of water in an interior thereof, the central well defining an upper perimeter;
a recirculation system comprising a pump in fluid communication with the interior of the well below a standing water surface of the water, the pump configured to direct water from the well interior for treatment by at least one treatment device;
a slot extending along each of the plurality of walls above the standing water surface of the water, the slot being in fluid communication with the pump and configured to receive treated water from the at least one treatment device and to discharge the received treated water into the well interior.

13. The waterfall hot tub of claim 12 further comprising:
a channel extending along the upper perimeter, the channel having an interior upper edge between the channel and the well; and
a cover overlying the channel and defining an inner edge extending substantially along the interior upper edge;
wherein the interior upper edge of the channel and the inner edge of the cover cooperate to define the slot.

14. The waterfall hot tub of claim 13, the channel being in fluid communication with the pump and configured to receive treated water from the at least one treatment device, whereby excess treated water received within the channel may flow over the interior upper edge and through the slot.

15. The waterfall hot tub of claim 14, the cover being releasably secured to the upper perimeter.

16. The waterfall hot tub of claim 14 further comprising at least one control for adjusting the rate of flow of treated water into the channel.

17. The waterfall hot tub of claim 16, the control being configured to allow adjustment of the rate of flow of treated water into the channel to a sufficiently high magnitude that treated water discharged through the slot projects inwardly from the slot and away from the walls.

18. The waterfall hot tub of claim 17, the control being further configured to allow adjustment of the rate of flow of treated water into the channel to a sufficiently low magnitude that treated water discharged through the slot flows downward along the walls.

19. The waterfall hot tub of claim 18, each of the walls cooperating to define a cascade zone extending inward of, and beneath, the slot.

20. The waterfall hot tub of claim 19, the cascade zone comprising a plurality of inwardly and downwardly tapered steps, each step extending substantially parallel to the slot.
